(19) United States
(12) Patent Application Publication
(10) Pub. No.: US 2005/0128606 A1
(43) Pub. Date: Jun. 16, 2005

(54) Holding device for placing an optical component in front of a laser light source, a corresponding system and a method for producing a system of this type

(76) Inventor: Vitalij Lissotschenko, Frondenberg (DE)

Correspondence Address: Stewart L Gitler;Hoffman Wasson & Gitler, Crystal Center 2 Suite 522, 2461 South Clark Street, Arlington, VA, 22202, US

(21) Appl. No.: 10/501,191

(22) PCT Filed: Nov. 8, 2002
(86) PCT No.: PCT/EP02/12463

(30) Foreign Application Priority Data
Jan. 15, 2002 (DE) 102 04 799.5

(51) Int. Cl. G02B 7/02

(52) U.S. Cl. 359/819

(57) ABSTRACT

Holding device for the arrangement of at least one optical component in front of a laser light source of a laser unit, including a first holding part to which at least one optical component is attached, the holding device furthermore including a second holding part which is attached to one part of the laser unit, and the first holding part being attached to the second holding part. Furthermore this invention relates to an arrangement with such a holding device and a process for producing this arrangement.

### BACKGROUND OF THE INVENTION

This invention relates to a holding device for the arrangement of at least one optical component in front of a laser light source of a laser unit, including a first holding part to which at least one optical component is attached. Furthermore, this invention relates to an arrangement of at least one optical component in front of a laser light source of a laser unit with such a holding device. Furthermore, this invention relates to a process for producing such an arrangement.

A holding device and an arrangement of the aforementioned type have been known for a long time from the existing art. For example, the laser light source can be made as a semiconductor laser, especially as a laser diode bar. The laser unit which makes up this laser diode bar is generally made such that the laser diode bar is mounted on a heat sink. The optical component which is to be placed in front of the laser diode bar is usually made as a fast-axis collimation lens which must be positioned relatively exactly in front of the laser diode bar in order to achieve unobjectionable beam quality. According to the existing art, a first holding part is cemented, for example, to the heat sink for this positioning. The optical component which is made as a fast-axis collimation lens can be cemented to this holding part at the corresponding given position. Usually a cement which can be cured by UV radiation is used here.

The disadvantage in such a holding device, or such an arrangement, is that before curing of the cement, the optical component can be positioned very exactly in front of the laser diode bar so that a beam of the desired quality results before curing. But the curing of the cement slightly shifts the optical component relative to the laser unit and thus relative to the laser light source, so that with the holding devices known from the existing art, only beam qualities of laser light sources which do not often meet requirements can be achieved. Another disadvantage is the often different coefficient of expansion of the heat sink, the cement and the holding device so that when temperatures change the positioning of the optical component in front of the laser light source is likewise disturbed.

An object of this invention is to devise a holding device and an arrangement of the initially mentioned type which ensure more accurate and more stable positioning of an optical component in front of a laser light source. Furthermore, an object of this invention is to devise a process for producing such an arrangement.

### SUMMARY OF THE INVENTION

The invention calls for the holding device to include a second holding part which is attached to one part of the laser unit, the first holding part being attached to the second holding part. As a result of the fact that two holding parts which are to be joined to one another are being used, different coefficients of expansion of the materials used can be equalized. Furthermore, the two holding parts which are connected to one another can be shaped and positioned such that the displacements to one another which arise when connecting agents such as cement or solder cure equalize.

With the process as described in the invention, in one process step the first holding part can be joined to the first optical component and in a second process step the second holding part can be joined to one part of the laser unit. Subsequently, the first holding part can be joined to the second holding part. Such a process offers the advantage that the first holding part is cemented to the optical component and the second holding part is cemented to one part of the laser unit, these cemented connections being cured. Only subsequently are the two holding parts joined to one another, and before curing of the cement which joins these two holding parts to one another the optical component can be positioned exactly in front of the laser light source. Instead of cement connections, solder connections can also be used.

Here it can be provided that one of the holding parts has a connecting section which is surrounded at least in sections by the receiving section of the other of the holding parts. For example, the second holding part can have a connecting section which is surrounded at least in sections by the receiving section of the first holding part. By surrounding the connecting section of one of the holding parts, by the receiving section of the other of the holding parts, the forces which occur when the cement or the solder cures are distributed more uniformly in different directions so that de-positioning by the curing of the cement or of the solder is reduced.

In particular, the connecting section can have an essentially cylindrical outside contour, the receiving section having an essentially hollow cylindrical inside contour, the connecting section being placed at least partially in the receiving section. Here there can be an annular intermediate space between the outside contour and the inside contour. This intermediate space can be filled, at least partially, with cement or solder. Based on the rotationally symmetrical coaxial configuration of the receiving section, and connecting section, the forces which occur when the cement which is located in the intermediate space cures can be comparatively exactly cancelled out. With the holding device, as described in the invention, the optical component can be positioned exactly in front of the laser light source such that the beam quality of the light which emerges from the laser light source is drastically improved. For example, the beam quality can be improved such that the laser light is coupled into the glass fiber much better, for example, with respect to its energy density, 40% better.

The annular intermediate space, which can be partially filled with cement, or solder, can have a radial dimension of 10 microns to 200 microns, preferably of roughly 50 microns. The displacements which are possible when the cement cures are further minimized by this very small intermediate space.

According to one preferred embodiment of this invention, an intermediate layer is inserted between the part of the laser unit to which the second holding part is attached, and the corresponding contact surface of the second holding part. This intermediate layer can be, for example, heat-insulating so that the first and the second holding part are less influenced by the heating-up of the laser unit.

With respect to the arrangement, as described in the invention, it can be provided that the laser unit as the laser light source includes a laser diode bar or a stack of laser diode bars.

In particular, the part to which the second holding part is attached can be a heat sink. The first optical component can be made as a fast-axis collimation lens. Furthermore it is possible for the second optical component which is made especially as a slow-axis collimation lens to be held on the laser unit via lateral support elements.

With respect to the process, as described in the invention, it can furthermore be provided that the hollow cylindrical inside contour is applied to the cylindrical outside contour and is cemented or soldered to it. In doing so, after application of the inside contour to the outside contour the first optical component can be positioned in front of the laser light source, in a subsequent process step the cement which joins the outside contour and the inside contour being cured, and this curing can take place for example by UV irradiation. Based on the aforementioned coaxially rotationally symmetrical configuration of the inside contour and outside contour, after exact positioning of the optical component in front of the laser light source only very small displacements of the component relative to the laser light source will take place, because the forces which occur during curing can be compensated.

### BRIEF DESCRIPTION OF THE DRAWINGS

Other features and advantages of this invention become clear based on the following description of preferred embodiments with reference to the attached figures.

FIG. 1 shows a perspective view of the arrangement as claimed in the invention with a holding device as claimed in the invention;

FIG. 2 shows another perspective view of the arrangement with the holding device as shown in FIG. 1;

FIG. 3 shows a side view of the arrangement with a holding device as shown in FIG. 1;

FIG. 4 shows a view as shown by the arrow IV in FIG. 3;

FIG. 5 shows a side view of another embodiment of an arrangement as claimed in the invention with a holding device as claimed in the invention;

FIG. 6 shows a detailed view as shown by the arrow VI in FIG. 3;

FIG. 7 shows a detailed view as shown by the arrow VII in FIG. 4;

FIG. 8 shows a view as shown by the arrow VIII in FIG. 5;

FIG. 9 shows a sectional view as shown by the arrows IX-IX in FIG. 8; and

FIG. 10 shows a detailed view as shown by the arrow X in FIG. 9.

### DETAILED DESCRIPTION OF THE INVENTION

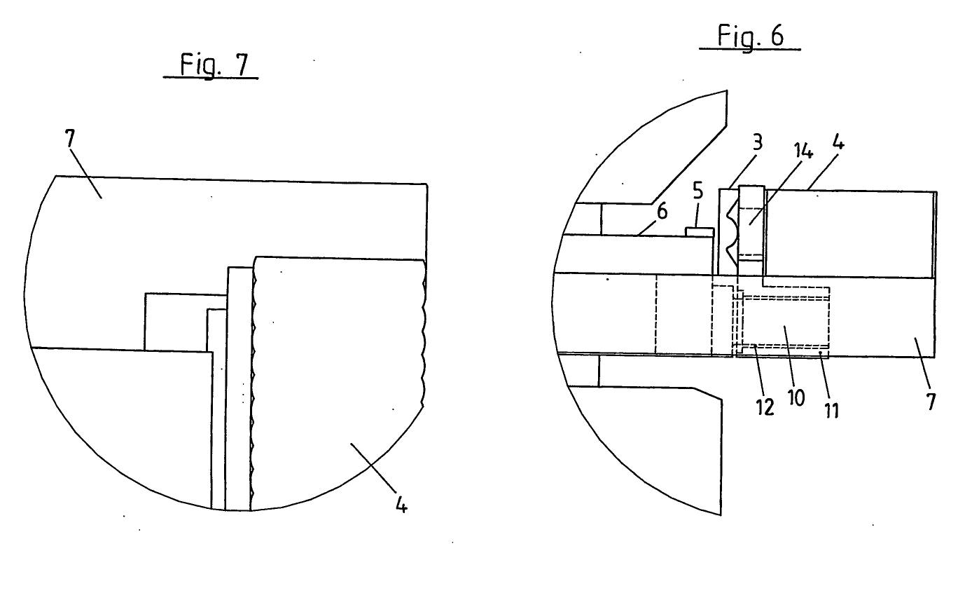

The arrangement shown in FIG. 1-4 includes a laser unit 1, a holding device 2 as described in the invention and as well as a first optical component 3 and a second optical component 4. The laser unit 1 includes a laser light source 5 which is made as a laser diode bar in the embodiment shown. Alternatively, a laser light source 5 can also be made as a stack of laser diode bars. The laser diode bar which is used as a laser light source 5, as is shown especially in FIG. 6 and FIG. 10, is mounted on the heat sink 6.

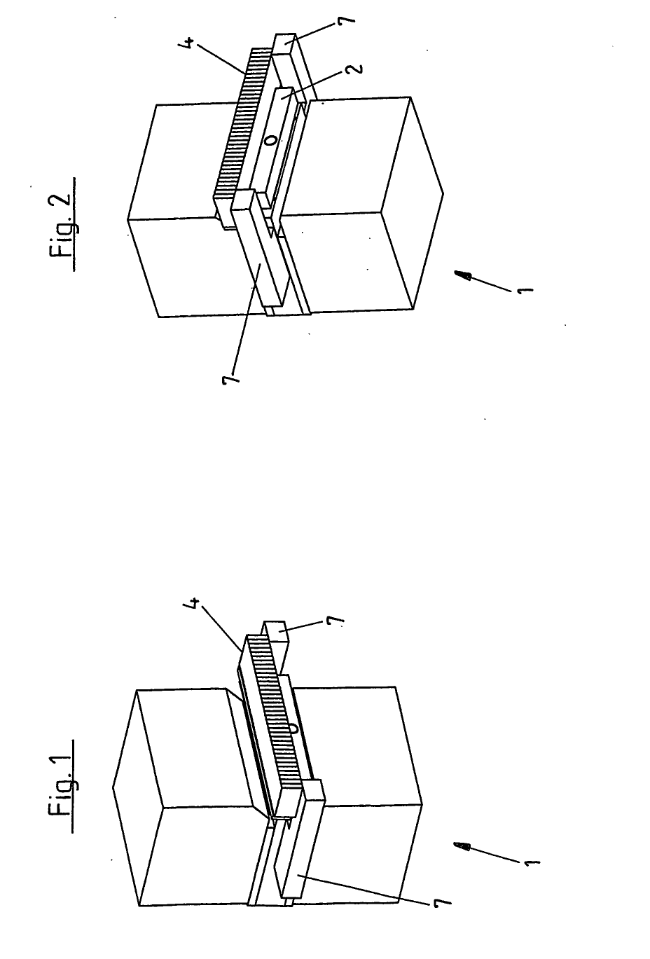

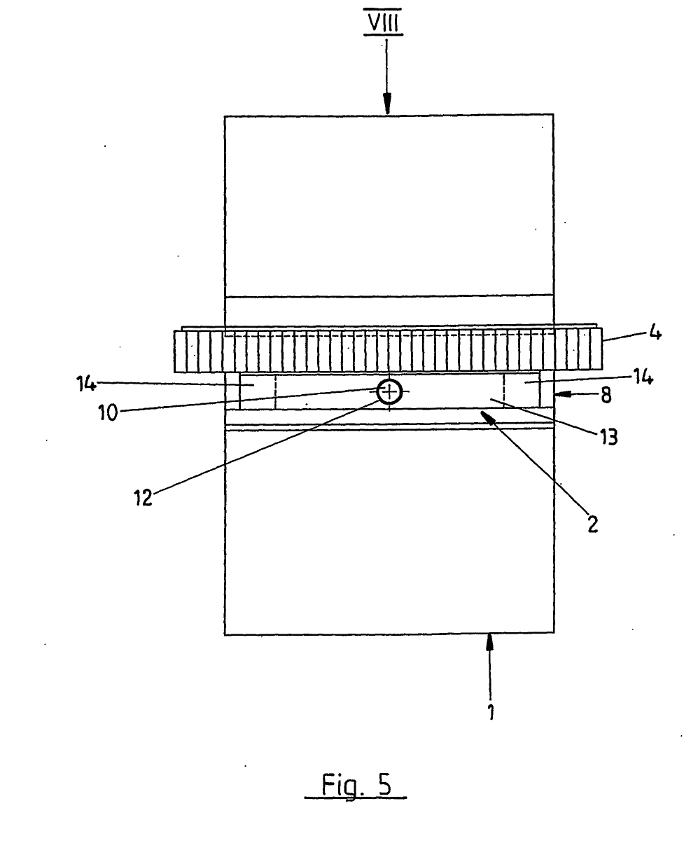

The first optical component 3 is made as a fast-axis collimation lens in the illustrated embodiment. The second optical component 4 in the illustrated embodiment is made as a slow-axis collimation lens. This slow-axis collimation lens, as is shown in FIG. 1, FIG. 2 and FIG. 5, has individual lens sections which are assigned to individual emission centers of the laser diode bar in the transverse direction of the laser light source 5.

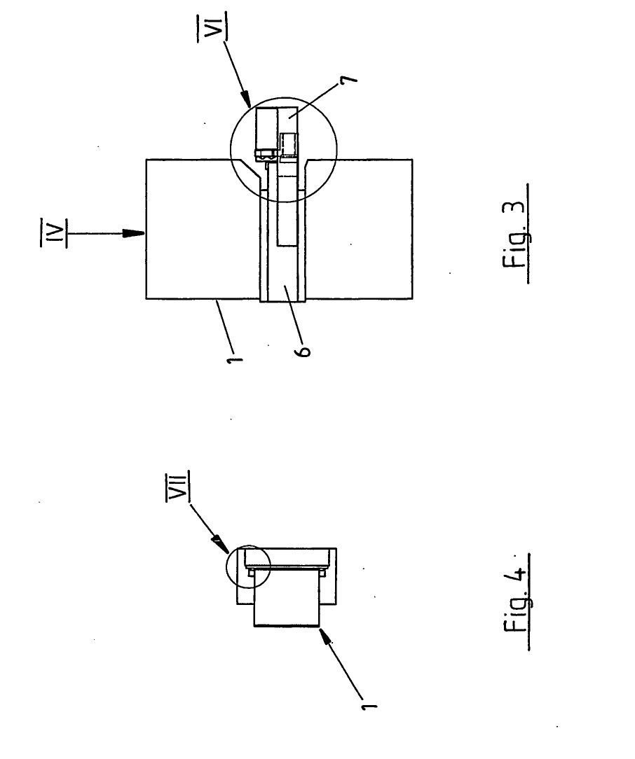

In the illustrated embodiment as shown in FIG. 1 to FIG. 4, the second optical component 4 is held by lateral support elements 7 which in the illustrated embodiment are attached to the heat sink 6 and proceeding from its outside extend to the right in FIG. 3. These two lateral support elements 7 form outer lateral supports on which the outer lower edges of the second optical component 4 rest. This is shown especially in FIG. 1, FIG. 2 and FIG. 7.

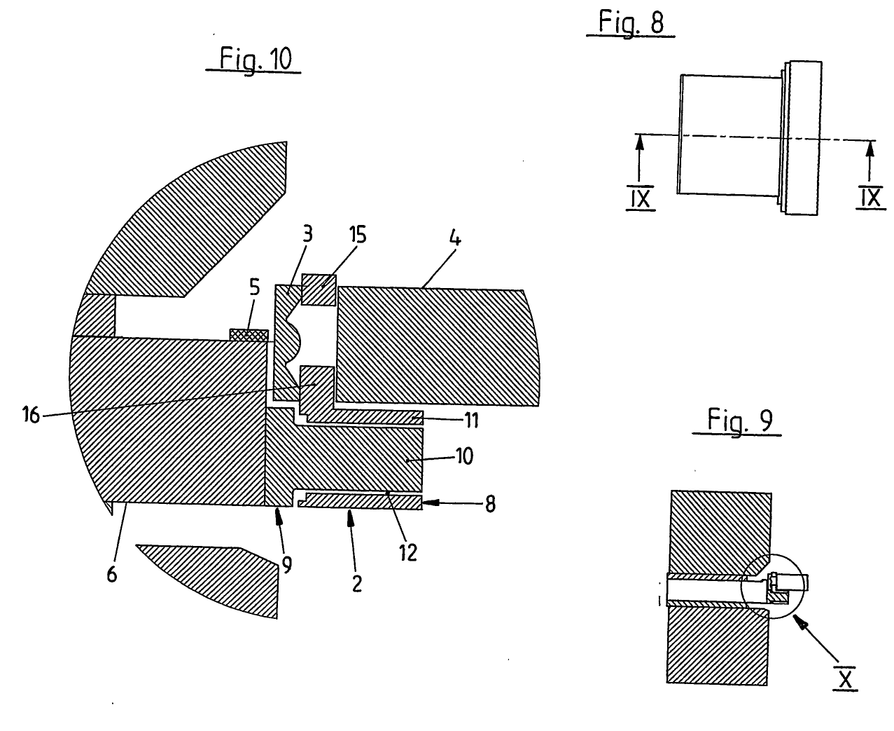

In FIG. 5 and FIG. 8 to FIG. 10 the lateral support elements 7 are omitted in order to make the features associated with the holding device as described in the invention more clear.

The holding device 2 as described in the invention, as is apparent especially from FIG. 10, includes a first holding part 8 which holds the first optical component 3, and furthermore a second holding part 9 which is connected to one part of the laser unit 1, specifically to the heat sink 6. The second holding part 9 has a connecting surface which faces the heat sink 6 and which is cemented or soldered for example to the surface of the heat sink 6 facing the second holding part 9. Alternatively it is also possible to provide an intermediate layer which has, for example, a heat-insulating material between the heat sink 6 and the connecting surface of the second holding part 9.

On its side facing away from the heat sink 6 the second holding part 9 has a cylindrical outside contour 10. This cylindrical outside contour 10 is surrounded by the hollow-cylindrical inside contour 11 of the first holding part 8 in the interconnected state of the two holding parts 8, 9. Before the two holding parts 8, 9 are fixed to one another, between the outside contour 10 and the inside contour 11 there is an annular intermediate space 12 which can have a very small radial dimension of 50 microns, for example.

The hollow cylindrical inside contour 11 is made on the first holding part 8 in one leg 13 of the holding part 8 which extends underneath the first optical component 3 which is made as a fast-axis collimation lens, over its entire width. From this transversely running leg 13 there extend outer lateral vertical legs 14 up in FIG. 5 which are joined to the upper contact leg 15 which extends on the top of the first optical component 3 over its width. Another lower contact leg 16 is directly connected to the transversely running leg 13. The two contact legs 15, 16 between over a large part of the width of the first optical component 3 which is made as a fast-axis collimation lens [sic] leave exposed the optically functional cylinder surfaces of the first optical component 3, so that the laser light emerging from the laser diode bar can be collimated with respect to its fast-axis divergence.

The arrangement, as described in the invention, can be produced by the second holding part 9 being attached to the laser unit 1 in a first process step. This can take place by cementing or soldering the contact surface of the second holding part 9 to the heat sink 6. Optionally, an intermediate layer can be inserted between the heat sink 6 and the contact surface. In another process step, the first optical component 3 can be attached to the first holding part 8, for example, by cementing. Subsequently the hollow cylindrical inside contour 11 of the first holding part 8 is applied to the cylindrical outside contour 10 of the second holding part 9, and the cylindrical outside contour 10 can be covered beforehand with a cement. Subsequently the first optical component 3 can be positioned exactly in front of the laser light source 5. Subsequently the cement can be cured for example by illumination with UV light.

Alternatively, the intermediate space 12 can be filled with solder and the optical component 3 can be positioned exactly in front of the laser light source 5 before hardening and curing of the solder.

As a result of the fact that the cement or the solder essentially completely fills the intermediate space 12 which is made annular or in the shape of a cylindrical shell, if necessary the forces which arise during curing are essentially cancelled so that by curing the cement no noticeable displacements of the first holding part 8 relative to the second holding part 9 occur.

1. A holding device for the arrangement of at least one optical component in front of a laser light source of a laser unit, comprising a first holding part to which at least one optical component is attached, wherein the holding device further comprises a second holding part which is attached to one part of the laser unit, the first holding part being attached to the second holding part.

2. A holding device as claimed in claim 1, wherein one of the holding parts has a connecting section which is surrounded at least in sections by the receiving section of the other of the holding parts.

3. A holding device as claimed in claim 2, wherein the connecting section has an essentially cylindrical outside contour and wherein the receiving section has an essentially hollow cylindrical inside contour, the connecting section being placed at least partially in the receiving section.

4. A holding device as claimed in claim 3, wherein there is an annular intermediate space between the outside contour and the inside contour.

5. A holding device as claimed in claim 4, wherein the intermediate space has a radial dimension of 10 microns to 200 microns.

6. A holding device as claimed in claim 4, wherein the intermediate space is at least partially filled with cement or solder.

7. A holding device as claimed in claim 1, wherein an intermediate layer is inserted between the part of the laser unit to which the second holding part is attached, and the corresponding contact surface of the second holding part.

8. An arrangement with a holding device as claimed in claim 1, wherein the laser unit as the laser light source comprises a laser diode bar or a stack of laser diode bars.

9. The arrangement as claimed in claim 8, wherein the part to which the second holding part is attached is a heat sink.

10. The arrangement as claimed in claim 8, wherein the at least one optical component is made as a fast-axis collimation lens.

11. The arrangement as claimed in claim 8, wherein a second optical component which is made as a slow-axis collimation lens is held on the laser unit via lateral support elements.

12. A process for producing an arrangement as claimed in claim 8, wherein in one process step the first holding part is joined to the at least one optical component, wherein in a further process step the second holding part is joined to one part of the laser unit, and wherein in a process step which follows these two process steps the first holding part is connected to the second holding part.

13. The process as claimed in claim 12, wherein the first and second parts are joined by a hollow cylindrical inside contour being applied to the cylindrical outside contour and being cemented or soldered to it.

14. The process as claimed in claim 13, wherein after application of the inside contour to the outside contour the at least one optical component is positioned in front of the laser light source, and wherein in a subsequent process step the cement or solder which joins the outside contour and the inside contour is cured.

15. The process as claimed in claim 14, wherein the cement is cured by UV irradiation.
